(19) United States
(12) Patent Application Publication
(10) Pub. No.: US 2025/0106874 A1
(43) Pub. Date: Mar. 27, 2025

(54) SUSPENSION AND RESUMPTION OF A MULTICAST/BROADCAST SERVICE

(71) Applicant: QUALCOMM Incorporated, San Diego, CA (US)

(72) Inventors: Chiranjib SAHA, Lakeside, CA (US); Prasada Veera Reddy KADIRI, San Diego, CA (US); Umesh PHUYAL, San Diego, CA (US)

(21) Appl. No.: 18/894,691

(22) Filed: Sep. 24, 2024

Related U.S. Application Data
(60) Provisional application No. 63/585,767, filed on Sep. 27, 2023.

(51) Int. Cl. H04W 72/30; H04W 76/40

(52) U.S. Cl. CPC H04W 72/30; H04W 76/40

(57) ABSTRACT

In some implementations, a first network node may receive, from a second network node, a first multicast/broadcast service (MBS) data activity message that indicates that no downlink data is available for transmission in an active MBS session. The first network node may transmit, to a third network node and based at least in part on receiving the first MBS data activity message, a multicast/broadcast radio bearer (MRB) context suspension indication that indicates that an MRB context associated with the active MBS session is to be suspended.

### CROSS-REFERENCE TO RELATED APPLICATION

This Patent Application claims priority to U.S. Provisional Patent Application No. 63/585,767, filed on Sep. 27, 2023, entitled “SUSPENSION AND RESUMPTION OF A MULTICAST/BROADCAST SERVICE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for suspension and resumption of a multicast/broadcast service.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first network node. The method may include receiving, from a second network node, a first multicast/broadcast service (MBS) data activity message that indicates that no downlink data is available for transmission in an active MBS session. The method may include transmitting, to a third network node and based at least in part on receiving the first MBS data activity message, a multicast/broadcast radio bearer (MRB) context suspension indication that indicates that an MRB context associated with the active MBS session is to be suspended.

Some aspects described herein relate to a method of wireless communication performed by a first network node. The method may include receiving, from a second network node, an MRB context suspension indication that indicates that an MRB context associated with an active MBS session is to be suspended. The method may include transmitting, to the second network node and based at least in part on receiving the MRB context suspension indication, an MRB context suspension response that indicates a suspension status of the MRB context.

Some aspects described herein relate to a method of wireless communication performed by a first network node. The method may include transmitting, to a second network node, a first MBS data activity message that indicates that no downlink data is available for transmission in an active MBS session. The method may include receiving, from the second network node and based at least in part on transmitting the first MBS data activity message, an MRB tunnel context suspension request that requests that a tunnel context associated with the active MBS session be suspended.

Some aspects described herein relate to a first network node for wireless communication. The first network node may include one or more memories and one or more processors coupled to the one or more memories. The one or more processors may be individually or collectively configured to receive, from a second network node, a first MBS data activity message that indicates that no downlink data is available for transmission in an active MBS session. The one or more processors may be individually or collectively configured to transmit, to a third network node and based at least in part on receiving the first MBS data activity message, an MRB context suspension indication that indicates that an MRB context associated with the active MBS session is to be suspended.

Some aspects described herein relate to a first network node for wireless communication. The first network node may include one or more memories and one or more processors coupled to the one or more memories. The one or more processors may be individually or collectively configured to receive, from a second network node, an MRB context suspension indication that indicates that an MRB context associated with an active MBS session is to be suspended. The one or more processors may be individually or collectively configured to transmit, to the second network node and based at least in part on receiving the MRB context suspension indication, an MRB context suspension response that indicates a suspension status of the MRB context.

Some aspects described herein relate to a first network node for wireless communication. The first network node may include one or more memories and one or more processors coupled to the one or more memories. The one or more processors may be individually or collectively configured to transmit, to a second network node, a first MBS data activity message that indicates that no downlink data is available for transmission in an active MBS session. The one or more processors may be individually or collectively configured to receive, from the second network node and based at least in part on transmitting the first MBS data activity message, an MRB tunnel context suspension request that requests that a tunnel context associated with the active MBS session be suspended.

Some aspects described herein relate to a non-transitory computer-readable medium that stores a set of instructions for wireless communication by a first network node. The set of instructions, when executed by one or more processors of the first network node, may cause the first network node to receive, from a second network node, a first MBS data activity message that indicates that no downlink data is available for transmission in an active MBS session. The set of instructions, when executed by one or more processors of the first network node, may cause the first network node to transmit, to a third network node and based at least in part on receiving the first MBS data activity message, an MRB context suspension indication that indicates that an MRB context associated with the active MBS session is to be suspended.

Some aspects described herein relate to a non-transitory computer-readable medium that stores a set of instructions for wireless communication by a first network node. The set of instructions, when executed by one or more processors of the first network node, may cause the first network node to receive, from a second network node, an MRB context suspension indication that indicates that an MRB context associated with an active MBS session is to be suspended. The set of instructions, when executed by one or more processors of the first network node, may cause the first network node to transmit, to the second network node and based at least in part on receiving the MRB context suspension indication, an MRB context suspension response that indicates a suspension status of the MRB context.

Some aspects described herein relate to a non-transitory computer-readable medium that stores a set of instructions for wireless communication by a first network node. The set of instructions, when executed by one or more processors of the first network node, may cause the first network node to transmit, to a second network node, a first MBS data activity message that indicates that no downlink data is available for transmission in an active MBS session. The set of instructions, when executed by one or more processors of the first network node, may cause the first network node to receive, from the second network node and based at least in part on transmitting the first MBS data activity message, an MRB tunnel context suspension request that requests that a tunnel context associated with the active MBS session be suspended.

Some aspects described herein relate to an apparatus for wireless communication. The apparatus may include means for receiving, from a first network node, a first MBS data activity message that indicates that no downlink data is available for transmission in an active MBS session. The apparatus may include means for transmitting, to a second network node and based at least in part on receiving the first MBS data activity message, an MRB context suspension indication that indicates that an MRB context associated with the active MBS session is to be suspended.

Some aspects described herein relate to an apparatus for wireless communication. The apparatus may include means for receiving, from a network node, an MRB context suspension indication that indicates that an MRB context associated with an active MBS session is to be suspended. The apparatus may include means for transmitting, to the network node and based at least in part on receiving the MRB context suspension indication, an MRB context suspension response that indicates a suspension status of the MRB context.

Some aspects described herein relate to an apparatus for wireless communication. The apparatus may include means for transmitting, to a network node, a first MBS data activity message that indicates that no downlink data is available for transmission in an active MBS session. The apparatus may include means for receiving, from the network node and based at least in part on transmitting the first MBS data activity message, an MRB tunnel context suspension request that requests that a tunnel context associated with the active MBS session be suspended.

Aspects generally include a method, apparatus, system, computer program product, non-transitory computer-readable medium, user equipment, base station, network entity, network node, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4B are diagrams illustrating an example of establishing and releasing an MBS session, in accordance with the present disclosure.

FIGS. 5A-5B are diagrams illustrating an example associated with suspension and resumption of an MBS, in accordance with the present disclosure.

FIG. 6 is a diagram illustrating an example process performed, for example, at a first network node or an apparatus of a first network node, in accordance with the present disclosure.

FIG. 7 is a diagram illustrating another example process performed, for example, at a first network node or an apparatus of a first network node, in accordance with the present disclosure.

FIG. 8 is a diagram illustrating another example process performed, for example, at a first network node or an apparatus of a first network node, in accordance with the present disclosure.

FIG. 9 is a diagram of an example apparatus for wireless communication, in accordance with the present disclosure.

### DETAILED DESCRIPTION

A user equipment (UE) may receive data from a network via a multicast/broadcast service (MBS) session, in which data may be transmitted to various UEs using a multicast/broadcast radio bearer (MRB). In some examples, such as when there is no downlink data available for transmission in an active MBS session, the network may release a UE associated with the MBS session into a radio resource control (RRC) inactive state and/or release an MRB associated with the MBS session, such as for a purpose of conserving power, computing, and/or network resources associated with the MBS session. However, doing so may cause a network node to release an MRB context and/or an F1-user plane interface (F1-U) context associated with the active MBS session. Put another way, when the network releases all UEs associated with an MBS session into an inactive state, the network may indicate to a network node (e.g., a distributed unit (DU) network node) to release a lower layer configuration, and thus the network node may release an MRB context and/or an F1-U tunnel context associated with the MBS session. In some examples, when the F1-U tunnel and/or MRB context is released by the network node, signaling overhead and latency may be increased in connection with reestablishing the MRB context and/or F1-U tunnel context when data is to be transmitted in an active MBS session. More particularly, high-overhead procedures may be performed by the network node and/or the network to set up the F1-U tunnel, resulting in increased signaling overhead and thus increased power, computing, and network resource consumption, as well has high latency for reestablishing the F1-U tunnel when downlink transmissions resume for the active MBS session. On the other hand, if an F1-U tunnel remains active notwithstanding that no data is to be transmitted in the active MBS session, unnecessary resources may be allocated to the otherwise idle F1-U tunnel, resulting in reduced throughput and otherwise inefficient usage of network resources.

Some techniques and apparatuses described herein enable signaling and procedures for instructing a network node (e.g., a central unit-user plane (CU-UP) network node) to suspend an established F1-U tunnel, such as when no data is available for downlink transmission in an active MBS session. In some aspects, a first network node (e.g., a central unit-control plane (CU-CP)) may receive, from a second network node (e.g., a CU-UP), an MBS data activity message that indicates that no downlink data is available for transmission in an active MBS session. Based at least in part on receiving the first MBS data activity message, the first network node may transmit, to a third network node (e.g., a DU), an MRB context suspension indication that indicates that an MRB context associated with the active MBS session is to be suspended. In some other aspects, such as aspects not involving a split CU architecture (e.g., aspects in which a CU is associated with both control plane functionality and user plane functionality), the CU may both identify that no downlink data is available for transmission in an active MBS session, and, based at least in part on the determination, transmit, to a DU, the MRB context suspension indication. Additionally, or alternatively, the third network node (e.g., the DU) may transmit, to the first network node (e.g., the CU-CP and/or the CU), an MRB tunnel suspension request that requests that a tunnel associated with the active MBS session (e.g., an F1-U tunnel) be suspended. In such aspects, an F1-U tunnel associated with an active MBS session may be suspended, such as during a period of time when there is no data available for transmission in the active MBS session, such that the F1-U may be resumed when data becomes available with minimal signaling overhead and/or power, computing, and network resource consumption. As a result, the techniques and apparatuses described herein may result in decreased signaling overhead and reduced latency as compared to examples in which a F1-U tunnel needs to be reestablished when downlink transmissions resume for the active MBS session, and/or increased throughput and more efficient usage of network resources as compared to examples in which a F1-U tunnel remains active notwithstanding that no downlink data is available for transmission in the active MBS session.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

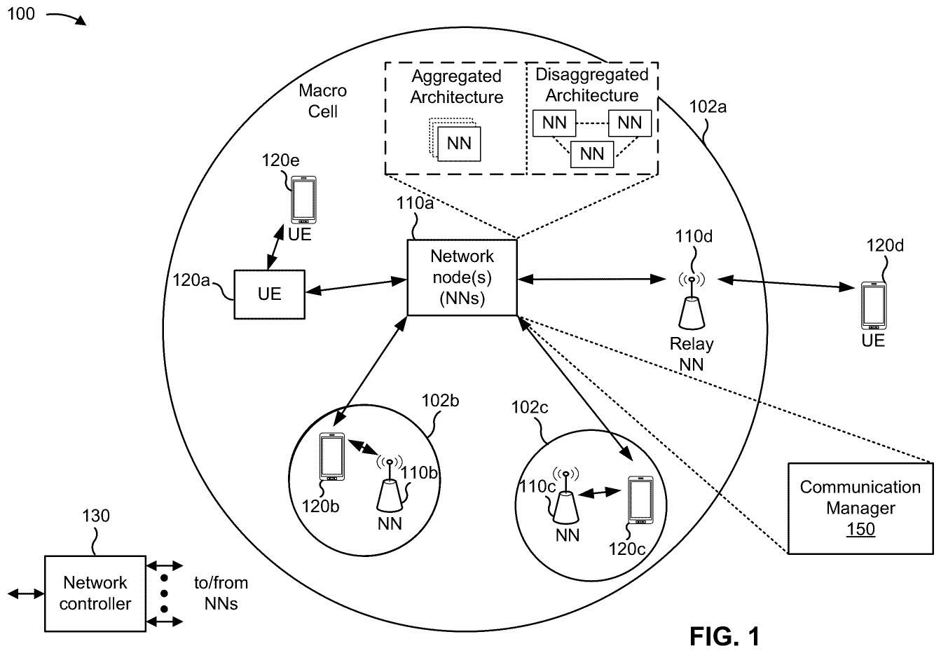

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more DUs, or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the network node 110 may include a communication manager 150. As described in more detail elsewhere herein, the communication manager 150 may receive, from a second network node, a first MBS data activity message that indicates that no downlink data is available for transmission in an active MBS session; and transmit, to a third network node and based at least in part on receiving the first MBS data activity message, an MRB context suspension indication that indicates that an MRB context associated with the active MBS session is to be suspended. In some other aspects, the communication manager 150 may receive, from a second network node, an MRB context suspension indication that indicates that an MRB context associated with an active MBS session is to be suspended; and transmit, to the second network node and based at least in part on receiving the MRB context suspension indication, an MRB context suspension response that indicates a suspension status of the MRB context. In some other aspects, the communication manager 150 may transmit, to a second network node, a first MBS data activity message that indicates that no downlink data is available for transmission in an active MBS session; and receive, from the second network node and based at least in part on transmitting the first MBS data activity message, an MRB tunnel context suspension request that requests that a tunnel context associated with the active MBS session be suspended. Additionally, or alternatively, the communication manager 150 may perform one or more other operations described herein.

As indicated above, FIG. 1 is provided as an example. Other examples may differ from what is described with regard to FIG. 1.

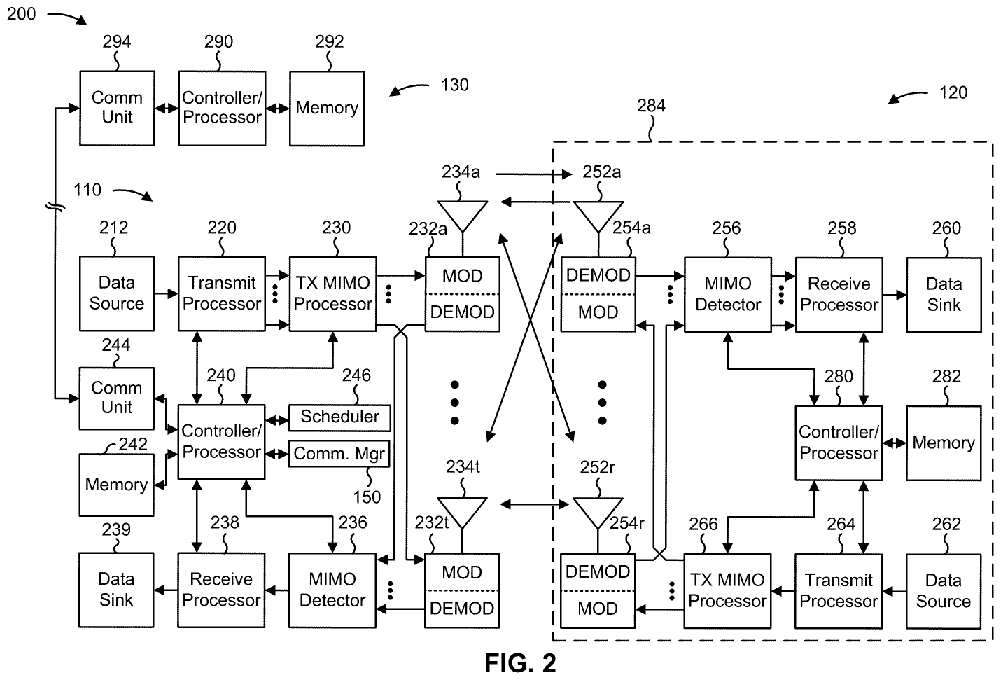

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

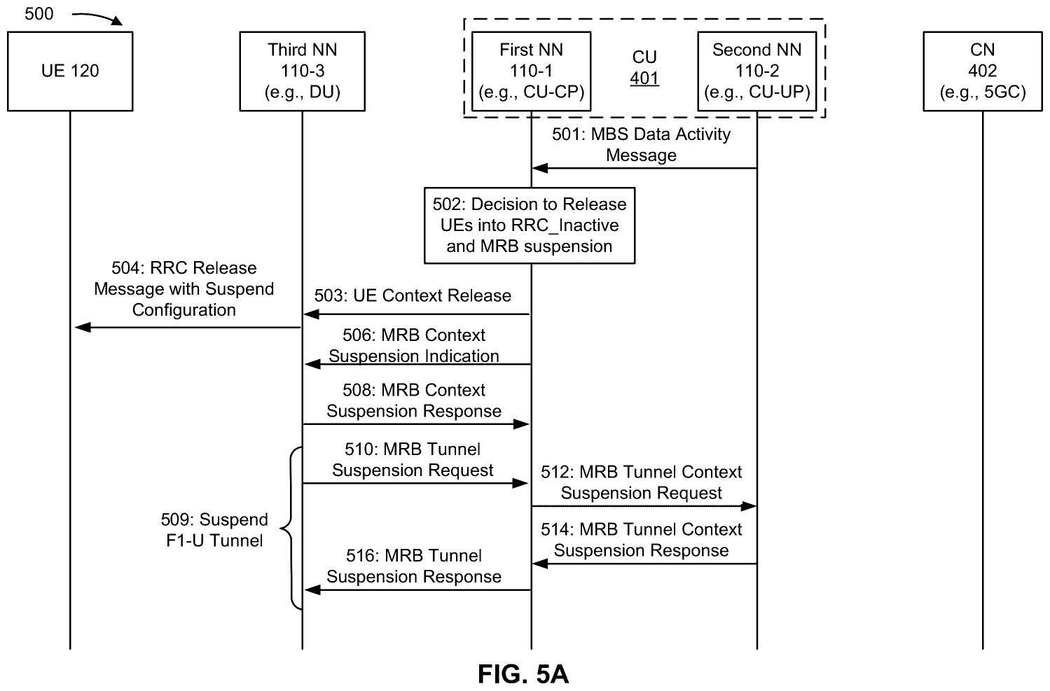

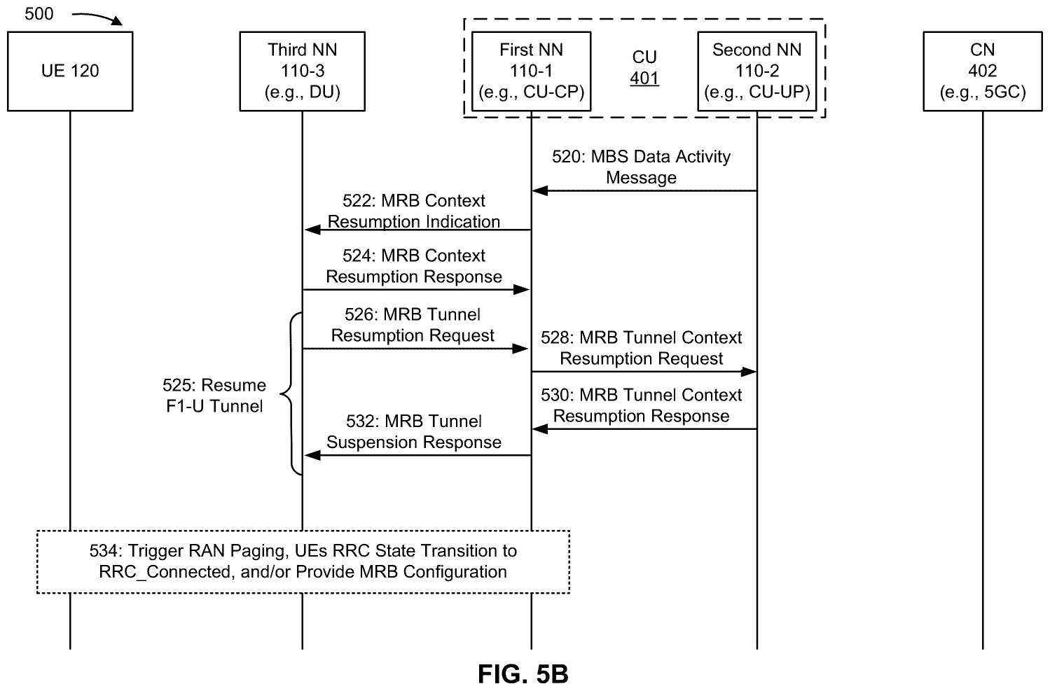

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-9).

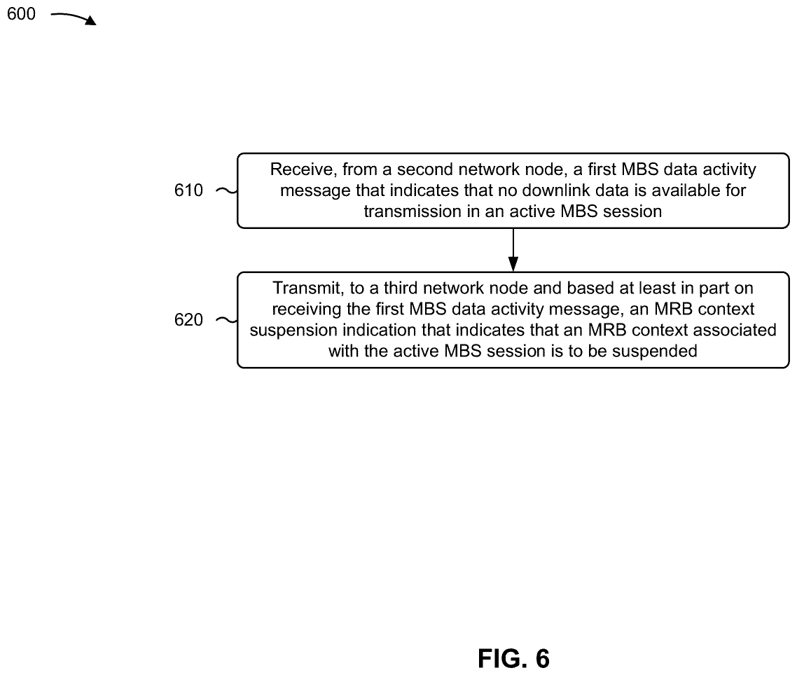

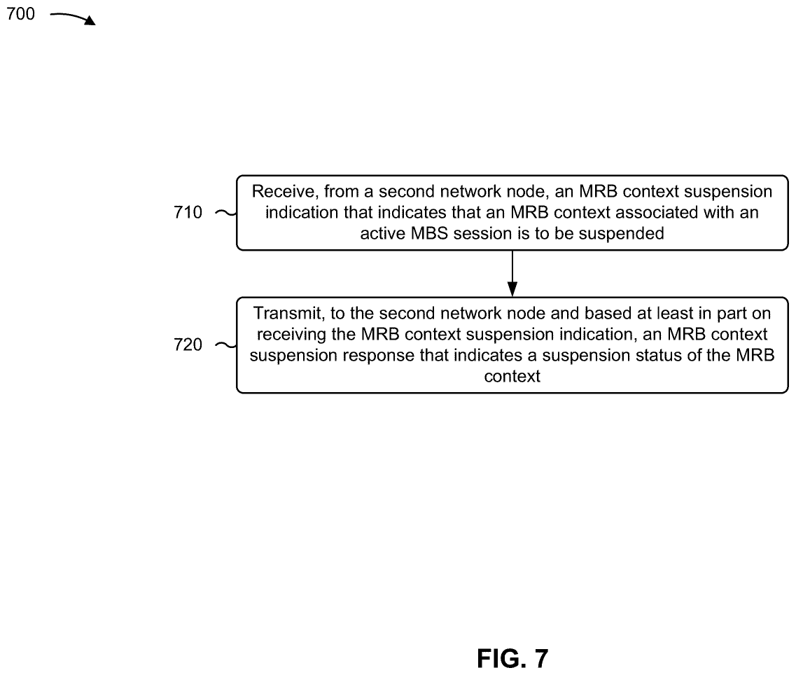

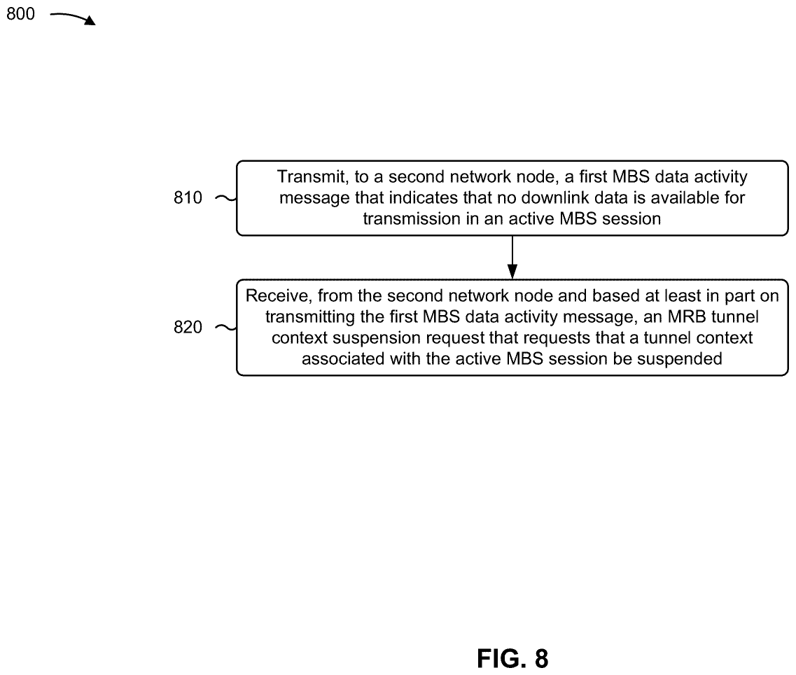

The controller/processor 240 of the network node 110, the controller/processor 280 of the UE 120, and/or any other component(s) of FIG. 2 may perform one or more techniques associated with suspension and resumption of an MBS, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the network node 110 (e.g., a first network node) includes means for receiving, from a second network node, a first MBS data activity message that indicates that no downlink data is available for transmission in an active MBS session; and/or means for transmitting, to a third network node and based at least in part on receiving the first MBS data activity message, an MRB context suspension indication that indicates that an MRB context associated with the active MBS session is to be suspended. In some other aspects, the network node 110 includes means for receiving, from a second network node, an MRB context suspension indication that indicates that an MRB context associated with an active MBS session is to be suspended; and/or means for transmitting, to the second network node and based at least in part on receiving the MRB context suspension indication, an MRB context suspension response that indicates a suspension status of the MRB context. In some other aspects, the network node 110 includes means for transmitting, to a second network node, a first MBS data activity message that indicates that no downlink data is available for transmission in an active MBS session; and/or means for receiving, from the second network node and based at least in part on transmitting the first MBS data activity message, an MRB tunnel context suspension request that requests that a tunnel context associated with the active MBS session be suspended. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

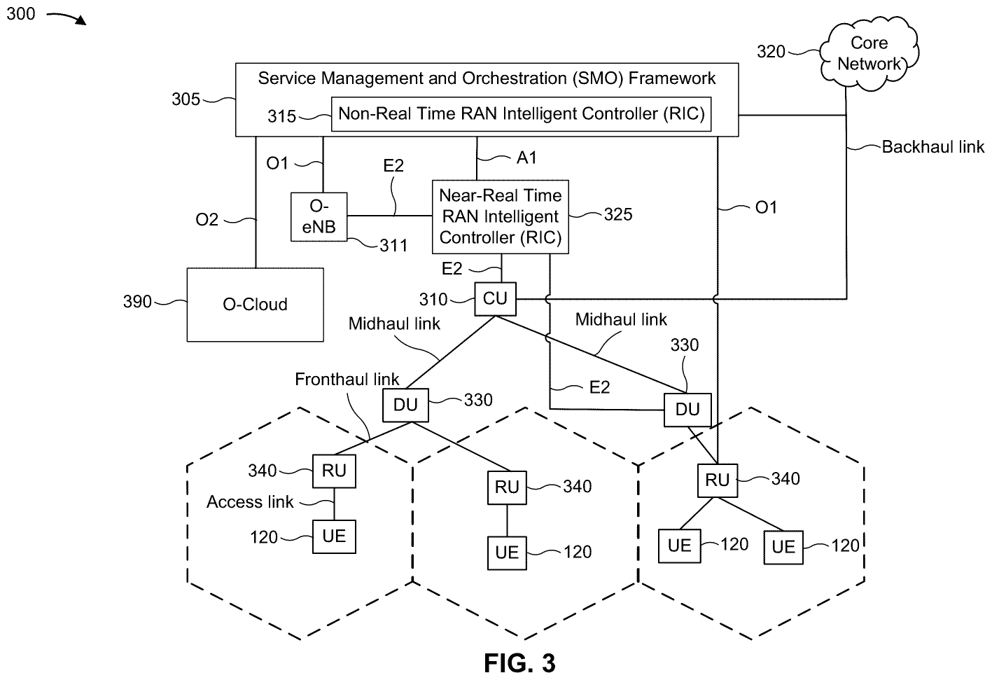

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, CU-UP functionality), control plane functionality (for example, CU-CP functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

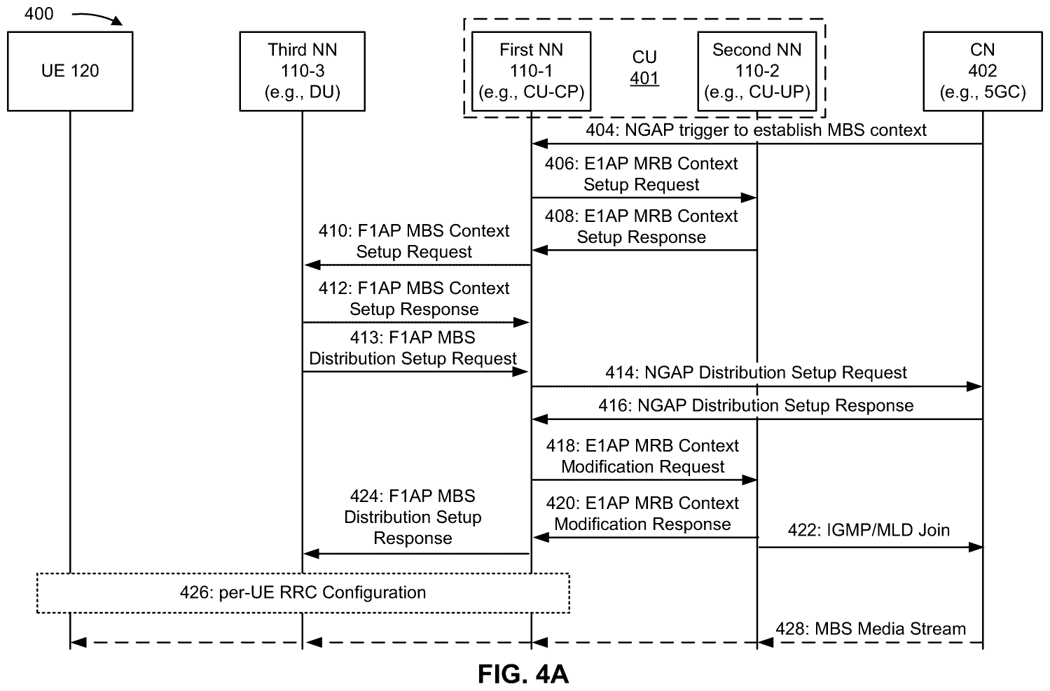

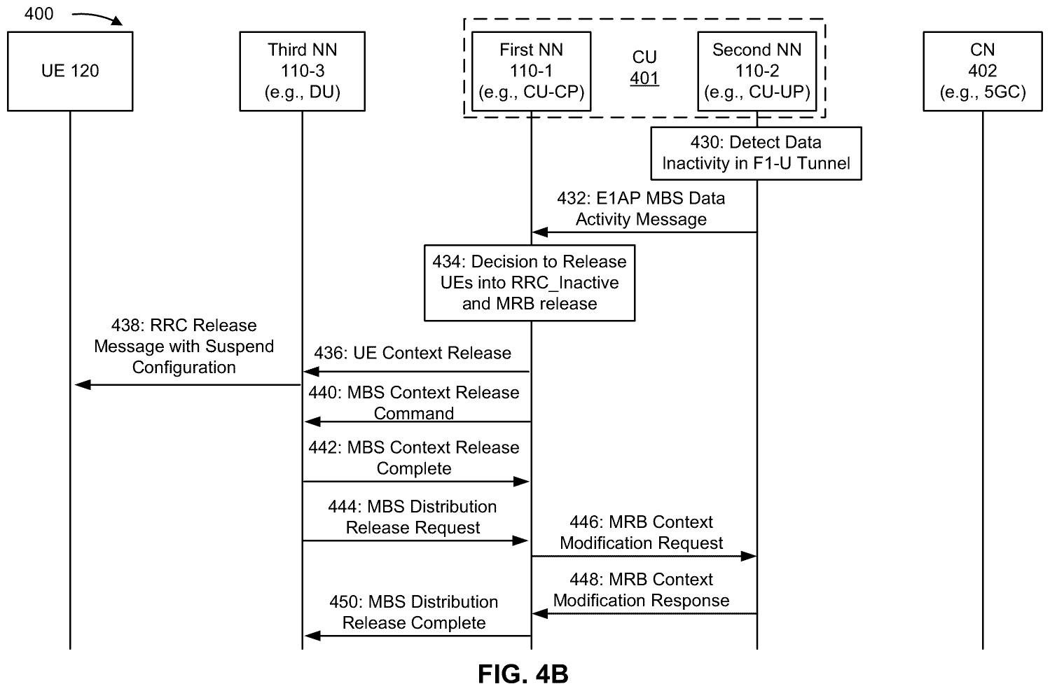

FIGS. 4A-4B are diagrams illustrating an example 400 of establishing and releasing an MBS session, in accordance with the present disclosure. As shown in FIGS. 4A-4B, various devices and nodes may be involved with establishing and suspending an MBS session, such as a UE 120, a first network node (shown as first network node 110-1, which may be a CU-CP network node), a second network node (shown as second network node 110-2, which may be a CU-UP network node), a third network node (shown as third network node 110-3, which may be a DU network node), and a core network (CN) entity 402 (e.g., an entity associated with a 5G core (5GC) or a similar CN). In some examples, such as examples not involving a split CU architecture (e.g., aspects in which a CU is associated with both control plane functionality and user plane functionality), the first network node 110-1 (e.g., CU-CP) and the second network node 110-2 (e.g., CU-UP) may be associated with a same CU 401 and/or signaling and/or operations described herein as being performed by one of the first network node 110-1 (e.g., CU-CP) or the second network node 110-2 (e.g., CU-UP) may be performed by the CU 401.

As shown in FIG. 4A, and as indicated by reference number 404, an MBS session may be established by the CN entity 402 transmitting, and the first network node 110-2 receiving, a message triggering establishment of an MBS context. For example, the 5GC may trigger establishment of an MBS context by transmitting a message to a CU-CP over an NG interface and/or using an NG application layer protocol (NGAP). As indicated by reference number 406, the first network node 110-1 may transmit, and the second network node 110-2 may receive, an MRB context setup request, requesting establishment of an MRB associated with the MBS session. In some examples, the MRB context setup request may include an indication of an MBS inactivity timer associated with the MBS session. An MBS inactivity timer may be associated with a period of time associated with data inactivity for an MBS session, such that, if no downlink data associated with the MBS session is transmitted during the period of time, the MRB associated with the MBS session may be suspended and/or UEs associated with the MBS may be transitioned into an inactive state (e.g., an RRC_inactive state), among other examples. As indicated by reference number 408, the second network node 110-2 may transmit, and the first network node 110-1 may receive, an MRB context setup response, acknowledging reception of the MRB context setup request, and/or providing tunnel information associated with the MRB, among other information. For example, the CU-UP may transmit the MRB context setup response to the CU-CP over an E1 interface and/or using an E1 application layer protocol (E1AP).

As shown by reference number 410, the first network node 110-1 may transmit, and the third network node 110-3 may receive, an MBS context setup request, requesting that the third network node 110-3 establish an MBS context associated with the MBS session, and/or providing tunnel information associated the MRB, among other information. For example, the CU-CP may transmit the MBS context setup request to a DU using an F1 interface and/or using an F1 application layer protocol (F1AP). As indicated by reference number 412, the third network node 110-3 may transmit, and the first network node 110-1 may receive, an MBS context setup response, acknowledging reception of the MBS context setup request. For example, the DU may transmit the MBS context setup response to the CU-CP over the F1 interface and/or using the F1AP.

As indicated by reference numbers 413 and 414, the third network node 110-3 may transmit, to the CN entity 402 via a two-stage process (e.g., via the first network node 110-1), an MBS distribution setup request, which may indicate tunnel information (e.g., F1-U DU tunnel information) associated with third network node 110-3 and/or the MBS session. More particularly, the DU may transmit the MBS distribution setup request to the CU-CP using the F1 interface and/or using the F1AP, which may indicate information related to an F1-U tunnel (e.g., a user plane tunnel associated with the F1 interface between the DU and the CU-UP) associated with the MBS session. In some examples, the F1-U tunnel information may be associated with an MBS F1-U context, which may be a block of information associated with a DU to control F1-U tunnels associated to the MRB contexts established for an MBS session. In some examples, an MBS F1-U context may be established per DU, per cell served by the DU, per MBS area session identifier (ID) served by the DU, for point-to-point retransmissions, for point-to-point forwarding, or for a point-to-point-only MRB leg, among other examples. In some examples, multiple MBS F1-U contexts may exist in parallel at a DU for the same MBS session.

The CU-CP may forward the information indicated in the MBS context information setup request to the 5GC via the NG interface and/or the NGAP, which may include information about an NG-U tunnel (e.g., a user plane tunnel associated with the NG interface between the CU-CP and the 5GC) associated with the distribution setup request. As indicated by reference number 416, the CN entity 402 may transmit, and the first network node 110-1 may receive, a distribution setup response, which may indicate NG-U tunnel information. For example, the 5GC may transmit the distribution setup response to the CU-CP using the NG interface and/or using the NGAP.

In some examples, as indicated by reference number 418, the first network node 110-1 may transmit, and the second network node 110-2 may receive, an MRB context modification request. For example, the CU-CP may transmit the MRB context modification request to the CU-UP using the E1 interface and/or using the E1AP. The MRB context modification request may indicate F1-U tunnel information (e.g., F1-U tunnel information associated with DU), NG-U tunnel information, and/or similar information. Additionally, or alternatively, in examples associated with the MBS inactivity timer described above in connection with reference number 406, the CU-CP may indicate the MBS inactivity timer via the MRB context modification request and/or the CU-CP may modify the MBS inactivity timer via the MRB context modification request. As indicated by reference number 420, the second network node 110-2 may transmit, and the first network node 110-1 may receive, an MRB context modification response. For example, the CU-UP may transmit the MRB context modification response to the CU-CP using the E1 interface and/or using the E1AP. In some examples, the MRB context modification response may include additional F1-U tunnel information (e.g., F1-U tunnel information associated with CU), among other information. In some examples, as indicated by reference number 422, the CU-UP may send a multicast registration message to the 5GC, such as for a purpose of joining an MBS stream. For example, the second network node 110-2 may transmit, and the CN entity 402 may receive, an Internet group management protocol (IGMP) and/or a multicast listener discovery (MLD) join message.

As indicated by reference number 424, the first network node 110-1 may transmit, and the third network node 110-3 may receive, an MBS distribution setup response. For example, the CU-CP may transmit the MBS distribution setup response to the DU using the F1 interface and/or using the F1AP. In some examples, the MBS distribution setup response may include F1-U tunnel information (e.g., F1-U tunnel information associated with CU), among other information. Based at least in part on the various contexts established for the MBS session via the various messages described above in connection with reference numbers 404-424, among other information, the first network node 110-1 (e.g., the CU-CP) and/or the third network node 110-3 (e.g., the DU) may configure one or more UEs 120 to receive the MBS service, as indicated by reference number 426. For example, a UE 120 may be capable of receiving data of an MBS session only while in an RRC connected state (e.g., RRC_connected state). Accordingly, if a UE 120 that joins an MBS session is in an RCC connected state when the MBS session is activated, the first network node 110-1 (e.g., the CU-CP) and/or the third network node 110-3 (e.g., the DU) may send an RRC reconfiguration message (e.g., an RRCReconfiguration message) to the UE 120 that indicates a corresponding MBS configuration for the MBS session.

Accordingly, as indicated by reference number 428, data associated with the MBS service may be transmitted to one or more UEs 120, such as the UE 120 shown in FIG. 4A. More particularly, an MBS data stream or similar information may be transmitted to each UE 120 associated with (e.g., subscribed to and/or configured with) the MBS session.

In some examples, when there is temporarily no data to be sent to the UEs 120 for an active MBS session, the first network node 110-1 (e.g., the CU-CP) and/or the third network node 110-3 (e.g., the DU) may transition the UE 120 to an RRC inactive state (e.g., RRC_inactive state), such as for a purpose of conserving power, computing, and/or network resources associated with the UE 120. In such examples, the first network node 110-1 (e.g., the CU-CP) and/or the third network node 110-3 (e.g., the DU) may use a group notification mechanism (e.g., MBS group paging, or the like) to notify the UE 120 in the RRC inactive state when the first network node 110-1 (e.g., the CU-CP) and/or the third network node 110-3 (e.g., the DU) has MBS session data to deliver to the UE 120. Upon reception of the group notification, the UE 120 may resume the connection (e.g., transition to an RRC connected state), such as for a purpose of receiving the MBS data stream.

More particularly, as shown in FIG. 4B, and as indicated by reference number 430, the second network node 110-2 (e.g., the CU-UP) may detect data inactivity in an F1-U tunnel. For example, the CU-UP may detect data inactivity based at least in part on no data associated with an active MBS being available for downlink transmission for a period of time associated with the MBS data activity timer, described above. In such examples, the second network node 110-2 may transmit, and the first network node 110-1 may receive, an MBS data activity message (sometimes referred to herein as a multicast (MC) bearer notification message and/or an MBS bearer notification message), as indicated by reference number 432. For example, the CU-UP may transmit the MBS data activity message to the CU-CP using the E1 interface and/or using the E1AP. As shown by reference number 434, based at least in part on receiving the MBS data activity message, the first network node 110-1 (e.g., the CU-CP) may decide to release one or more UEs 120 associated with the active MBS session to an RRC inactive state and/or to release an MRB associated with the active MBS session.

In that regard, in examples in which one or more UEs 120 (such as the UE 120 shown in FIG. 4B) are to be released to an RRC inactive state (e.g., an RRC_inactive state), the first network node 110-1 may transmit, and the third network node 110-3 may receive, a UE context release message, as indicated by reference number 436. For example, the CU-CP may transmit the UE context release message to the DU using the F1 interface and/or using the F1AP. In response, as indicated by reference number 438, the third network node 110-3 (e.g., the DU) may transmit, and the UE 120 may receive, an RRC release message with a suspend configuration, instructing the UE 120 to transition to the RRC inactive state. Moreover, in examples in which an MRB associated with the active MBS session is to be released, the first network node 110-1 may transmit, and the third network node 110-3 may receive, an MBS context release command, as shown by reference number 440. For example, the CU-CP may transmit the MBS context release command to the DU using the F1 interface and/or using the F1AP. In response, the third network node 110-3 may transmit, and the first network node 110-1 may receive, an MBS context release complete message, as indicated by reference number 442, indicating that the MBS context has been released. For example, the DU may transmit the MBS context release complete message to the CU-CP using the F1 interface and/or using the F1AP. In some examples, the MBS context release complete message may indicate that the DU released the MRB associated with the active MBS session.

Additionally, or alternatively, the third network node 110-3 may transmit, and the second network node 110-2 may receive (via the first network node 110-1), an MBS distribution release request, as indicated by reference numbers 444 and 446. For example, as indicated by reference number 444, the DU may transmit an MBS distribution release request to the CU-CP, such as by using the F1 interface and/or using the F1AP, and/or the CU-CP may transmit an MRB context modification request to the CU-CP, such as by using the E1 interface and/or using the E1AP. The MBS distribution release request may indicate that the MRB associated with the active MBS session is to be released and/or that the F1-U tunnel associated with the active MBS session is to be released. Accordingly, as indicated by reference number 448, the second network node may transmit, and the first network node 110-1 may receive, an MRB context modification response, which may indicate that the MRB context associated with the MBS session is to be released and/or that the F1-U tunnel associated with the MBS session has been released. For example, the CU-UP may transmit the MRB context modification response to the CU-CP using the E1 interface and/or using the E1AP. As indicated by reference number 450, based at least in part on receiving the MRB context modification response, the first network node 110-1 may transmit, and the third network node 110-3 may receive, an MBS distribution release complete message that indicates that the MRB context has been released and/or that the F1-U tunnel has been released. For example, the CU-CP may transmit the MBS distribution release complete message to the DU using the F1 interface and/or the F1AP.

In that regard, when there is no downlink data available for transmission in an active MBS session, a network node 110 may release a UE 120 into an RRC inactive state and/or release an MRB associated with the MBS session, such as for a purpose of conserving power, computing, and/or network resources associated with the MBS session. However, doing so may cause a network node 110 (e.g., a DU) to release an MRB context and/or an F1-U context associated with the active MBS session. Put another way, when a CU-CP releases all UEs associated with an MBS session into an inactive state, the CU-CP may indicate to the DU to release a lower layer configuration, and thus a DU may release an MRB context and/or an F1-U tunnel context. In some examples, when the F1-U tunnel and/or MRB context is released by the DU, signaling overhead and latency may be increased in connection with reestablishing the MRB context and/or F1-U tunnel context when data is to be transmitted in active MBS session. More particularly, in such examples, the procedures described above in connection with reference numbers 413-424 may need to be repeated in order to set up the F1-U tunnel, resulting in increased signaling overhead and thus increased power, computing, and network resource consumption, as well has high latency for reestablishing the F1-U tunnel when downlink transmissions resume for the active MBS session. On the other hand, if an F1-U tunnel remains active, notwithstanding that no data is to be transmitted in the active MBS session, unnecessary resources may be allocated to the otherwise idle F1-U tunnel, resulting in reduced throughput and otherwise inefficient usage of network resources.

Some techniques and apparatuses described herein enable signaling and procedures for instructing a network node (e.g., a CU-UP) to suspend an established F1-U Tunnel, such as when no data is available for downlink transmission in an active MBS session. In some aspects, a first network node (e.g., a CU-CP) may receive, from a second network node (e.g., a CU-UP), an MBS data activity message (e.g., an MC bearer notification message) that indicates that no downlink data is available for transmission in an active MBS session. Based at least in part on receiving the first MBS data activity message, the first network node may transmit, to a third network node (e.g., a DU), an MRB context suspension indication that indicates that an MRB context associated with the active MBS session is to be suspended. Additionally, or alternatively, the third network node (e.g., the DU) may transmit, to the first network node (e.g., the CU-CP), an MRB tunnel suspension request that requests that a tunnel associated with the active MBS session (e.g., an F1-U tunnel) be suspended. In such aspects, an F1-U tunnel associated with an active MBS session may be suspended, such as during a period of time when there is no data available for transmission in the active MBS session, such that the F1-U may be resumed when data becomes available with minimal signaling overhead and/or power, computing, and network resource consumption. As a result, the techniques and apparatuses described herein may result in decreased signaling overhead and reduced latency as compared to examples in which a F1-U tunnel needs to be reestablished when downlink transmissions resume for the active MBS session, and/or increased throughput and more efficient usage of network resources as compared to examples in which a F1-U tunnel remains active notwithstanding that no downlink data is available for transmission in the active MBS session.

As indicated above, FIGS. 4A-4B is provided as an example. Other examples may differ from what is described with respect to FIGS. 4A-4B.

FIGS. 5A-5B are diagrams illustrating an example 500 associated with suspension and resumption of an MBS, in accordance with the present disclosure. As shown in FIGS. 5A-5B, example 500 includes communication between the UE 120, the first network node 110-1 (e.g., CU-CP), the second network node 110-2 (e.g., CU-UP), the third network node 110-3 (e.g., DU), and the CN entity 402 (e.g., 5GC) described above in connection with Figs, 4A-4B. In some aspects, the UE 120, the first network node 110-1, the second network node 110-2, the third network node 110-3, and the CN entity 402 may be included in a wireless network, such as wireless network 100. Two or more of the UE 120, the first network node 110-1, the second network node 110-2, the third network node 110-3, and the CN entity 402 may communicate via a wireless access link, which may include an uplink and a downlink. In some aspects, the first network node 110-1 and the CN entity 402 may communicate via the NG interface and/or using the NGAP, the first network node 110-1 and the second network node 110-2 may communicate via the E1 interface and/or using the E1AP, and/or the first network node 110-1 and the third network node 110-3 may communicate via the F1 interface and/or using the F1AP. Additionally, or alternatively, in some aspects, such as aspects not involving a split CU architecture (e.g., aspects in which a CU is associated with both control plane functionality and user plane functionality), the first network node 110-1 (e.g., CU-CP) and the second network node 110-2 (e.g., CU-UP) may be associated with the same CU 401, and/or signaling and/or operations described herein as being performed by one of the first network node 110-1 (e.g., CU-CP) or the second network node 110-2 (e.g., CU-UP) may be performed by the CU 401, in a similar manner as described above in connection with FIGS. 4A-4B.

As shown in FIG. 5A, and indicated by reference number 501, in some aspects the second network node 110-2 (e.g., the CU-UP) may transmit, and the first network node 110-1 (e.g., CU-CP) may receive, a first MBS data activity message (e.g., a first MC bearer notification message), such as the MBS data activity message described above in connection with reference number 432. In that regard, the first MBS data activity message may indicate that no downlink data is available for transmission in an active MBS session. For example, in aspects in which the second network node 110-2 (e.g., CU-UP) is signaled with and/or otherwise configured with an MBS inactivity timer, the second network node 110-2 (e.g., CU-UP) may transmit the first MBS data activity message to the first network node 110-1 (e.g., CU-CP) based at least in part no data being available for transmission in the active MBS session for at least a period of time associated with the MBS inactivity timer. In some other aspects, such as in aspects in which the CU 401 performs both control plane and user plane functionality, the CU may identify that no downlink data is available for transmission in the active MBS session, such as in response to no data being available for transmission in the active MBS session for at least a period of time associated with the MBS inactivity timer, among other examples.

As indicated by reference number 502, based at least in part on receiving the first MBS data activity message, the first network node 110-1 (e.g., CU-CP) may decide to release one or more UEs associated with the active MBS session to an RRC inactive state, and/or the first network node 110-1 (e.g., CU-CP) may decide to suspend an MRB associated with the active MBS session. For example, the first network node 110-1 (e.g., CU-CP) may decide to release one or more UEs associated with the active MBS session to an RRC inactive state and/or to suspend an MRB associated with the active MBS session, such as for a purpose of conserving power, computing, and/or network resources associated with the otherwise idle UEs and/or MRB. In some other aspects, such as in aspects in which the CU 401 performs both control plane and user plane functionality, the CU 401 may decide to release one or more UEs associated with the active MBS session to an RRC inactive state, and/or the CU 401 may decide to suspend an MRB associated with the active MBS session.

In such aspects, as indicated by reference number 503, the first network node 110-1 (e.g., CU-CP) and/or the CU 401 may transmit, and the third network node 110-3 (e.g., DU) may receive, a UE context release message, which may be substantially similar to the UE context release message described above in connection with reference number 436. Additionally, or alternatively, as indicated by reference number 504, based at least in part on receiving the UE context release message, the third network node 110-3 (e.g., DU) may transmit, and the UE 120 may receive, an RRC release message with a suspend configuration, which may be substantially similar to the RRC release message described above in connection with reference number 438.

Moreover, as indicated by reference number 506, the first network node 110-1 (e.g., CU-CP) and/or the CU 401 may transmit, and the third network node 110-3 (e.g., DU) may receive, an MRB context suspension indication that indicates that an MRB context associated with the active MBS session is to be suspended. For example, the first network node 110-1 (e.g., CU-CP) and/or the CU 401 may transmit the MRB context suspension indication as part of an MBS context modification request, which may be similar to the MBS context release command described above in connection with reference number 440, but which may indicate that the MRB is to be suspended rather than released. In this regard, if downlink data is later available for transmission in the MBS session, the third network node 110-3 (e.g., DU) may resume the MRB without requiring the signaling overhead and resource consumption otherwise associated with an MRB and/or F1-U tunnel setup procedure.

As indicated by reference number 508, based at least in part on receiving the MRB context suspension indication, the third network node 110-3 (e.g., DU) may transmit, and the first network node 110-1 (e.g., CU-CP) and/or the CU 401 may receive, an MRB context suspension response that indicates a suspension status of the MRB context. For example, in aspects in which the third network node 110-3 (e.g., DU) was able to suspend the MRB based at least in part on receiving the MRB context suspension indication, the MRB context suspension response may indicate that the MRB is suspended. In some other aspects, such as in aspects in which the third network node 110-3 (e.g., DU) was unable to suspend the MRB, the MRB context suspension response may indicate that the MRB was not suspended, that the MRB remains active, or that the MRB was released, among other examples.

Additionally, or alternatively, as shown by reference number 509, the various network entities may exchange signaling in order to suspend an F1-U tunnel associated with the MBS session, such as for a purpose of freeing up resources otherwise associated with the F1-U tunnel when the F1-U tunnel is not in use (e.g., due to no data being available for downlink transmission in the MBS session). More particularly, as indicated by reference number 510, based at least in part on receiving the MRB context suspension indication, the third network node 110-3 (e.g., DU) may transmit, and the first network node 110-1 (e.g., CU-CP) and/or the CU 401 may receive, an MRB tunnel suspension request that requests that a tunnel associated with the active MBS session (e.g., an F1-U interface tunnel) be suspended. In some aspects, the MRB tunnel suspension request may be transmitted by the third network node 110-3 (e.g., DU) via an MBS distribution setup request, such as the MBS distribution setup request described above in connection with reference number 413. For example, the MRB tunnel suspension request may be transmitted via an information element (IE) included as part of the MBS distribution setup request, sometimes referred to as an MRB F1-U tunnel suspend IE. In some other aspects, the MRB tunnel suspension request may be transmitted via an MBS distribution modification request, which may transmitted using the F1 interface and/or the F1AP, and/or which may be similar to the MBS distribution setup request described above in connection with reference number 413 but which requests a modification to a previous MBS distribution setup request (e.g., in this aspect, a suspension of a previously established F1-U tunnel).

As indicated by reference number 512, in aspects involving a split CU architecture, and based at least in part on receiving the MRB tunnel suspension request, the first network node 110-1 (e.g., CU-CP) may transmit, and the second network node 110-2 (e.g., CU-UP) may receive, an MRB tunnel context suspension request that requests that a tunnel context associated with the active MBS session (e.g., an F1-U interface tunnel context) be suspended. For example, the first network node 110-1 (e.g., CU-CP) may transmit the MRB tunnel context suspension request via an MRB context modification request, which may be similar to the MRB context modification request described above in connection with reference numbers 418 and/or 446. Additionally, or alternatively, as indicated by reference number 514, based at least in part on receiving MRB tunnel context suspension request, the second network node 110-2 (e.g., CU-UP) may transmit, and the first network node 110-1 (e.g., CU-CP) may receive, an MRB tunnel context suspension response, which may acknowledge reception of the MRB tunnel context suspension request and/or which indicates a suspension status of the MRB tunnel context (e.g., an F1-U interface tunnel context). For example, in aspects in which the second network node 110-2 (e.g., CU-UP) suspends an F1-U interface tunnel based at least in part on receiving the MRB tunnel context suspension request, the second network node 110-2 (e.g., CU-UP) may indicate to the first network node 110-1 (e.g., CU-CP) that the F1-U interface tunnel has been suspended via the MRB tunnel context suspension response.

As indicated by reference number 516, the first network node 110-1 (e.g., CU-CP) and/or the CU 401 may transmit, and the third network node 110-3 (e.g., DU) may receive, an MRB tunnel suspension response indicating that the tunnel (e.g., the F1-U tunnel) is to be suspended. In some aspects, the first network node 110-1 (e.g., CU-CP) and/or the CU 401 may transmit the MRB tunnel suspension response via an IE included as part of an MBS distribution release complete message (e.g., the MBS distribution release complete message described above in connection with reference number 450), such as the MRB F1-U tunnel suspend IE described above in connection with reference number 510. In some other aspects, the MRB tunnel suspension response may be transmitted via an MBS distribution modification response, which may be transmitted using the F1 interface and/or the F1AP, and/or which may be similar to the MBS distribution release complete message described above in connection with reference number 450, but which indicates a modification to a previous MBS distribution setup request (e.g., in this aspect, a suspension of a previously established F1-U tunnel).

In this way, by using the signaling described above in connection with reference numbers 501-516, the various network entities (e.g., the first network node 110-1 (e.g., CU-CP), the second network node 110-2 (e.g., CU-UP), the third network node 110-3 (e.g., DU)), and/or the CU 401 may suspend an MRB associated with an active MBS session and/or suspend an F1-U tunnel associated with an active MBS session, such as for a purpose of reducing resource consumption as compared to maintaining an MRB and/or F1-U when no data is available for downlink transmission in an active MBS session.

In some aspects, by suspending the MRB and/or the F1-U tunnel rather than releasing the MRB and/or the F1-U tunnel when no data is available for downlink transmission in the active MBS session, the MRB and/or the F1-U tunnel may be quickly resumed, such as when data becomes available for downlink transmission in the active MBS session with minimal signaling overhead and/or without requiring high-latency MRB and/or F1-U tunnel setup operations. More particularly, as shown in FIG. 5B, and as indicated by reference number 520, in aspects involving a split CU architecture, the second network node 110-2 (e.g., CU-UP) may transmit, and the first network node 110-1 (e.g., CU-CP) may receive, a second MBS data activity message (e.g., a second MC bearer notification message) that indicates that downlink data is available for transmission in the active MBS session. In aspects not involving a split CU architecture (e.g., in aspects in which the CU 401 performs both control plane functionality and user plane functionality), the CU 401 may identify that downlink data is available for transmission in the active MBS session.

In that regard, based at least in part on receiving the second MBS data activity message (e.g., in split CU architectures) and/or identifying that downlink data is available for transmission, the first network node 110-1 (e.g., CU-CP) and/or the CU 401 may transmit, and the third network node 110-3 (e.g., DU) may receive, an MRB context resumption indication that indicates that the MRB context associated with the active MBS session is to be resumed, as indicated by reference number 522. As indicated by reference number 524, based at least in part on receiving the MRB context resumption indication, the third network node 110-3 (e.g., DU) may transmit, and the first network node 110-1 (e.g., CU-CP) and/or the CU 401 may receive, an MRB context resumption response that indicates a resumption status of the MRB context.

Moreover, as indicated by reference number 525, the various network entities (e.g., the first network node 110-1 (e.g., CU-CP), the second network node 110-2 (e.g., CU-UP), the third network node 110-3 (e.g., DU), and/or the CU 401) may exchange signaling in order to resume a previously suspended F1-U tunnel associated with the active MBS session (e.g., associated with the previously suspended, now resumed, MRB). More particularly, as indicated by reference number 526, based at least in part on receiving the MRB context resumption indication, the third network node 110-3 (e.g., DU) may transmit, and the first network node 110-1 (e.g., CU-CP) and/or the CU 401 may receive, an MRB tunnel resumption request that requests that a tunnel associated with the active MBS session (e.g., an F1-U interface tunnel) be resumed. In some aspects, the third network node 110-3 (e.g., DU) may transmit the MRB tunnel resumption request via an IE included as part of an MBS distribution setup request (e.g., sometimes referred to as an MRB F1-U tunnel resume IE, which may be similar to the MRB F1-U tunnel suspend IE described above). In some other aspects, the third network node 110-3 (e.g., DU) may transmit the MRB tunnel resumption request via an MBS distribution modification request, such as the MBS distribution modification request described above in connection with reference number 510.

As indicated by reference number 528, in aspects involving a split CU architecture, based at least in part on receiving the MRB tunnel resumption request, the first network node 110-1 (e.g., CU-CP) may transmit, and the second network node 110-2 (e.g., CU-UP) may receive, an MRB tunnel context resumption request that requests that a tunnel context associated with the active MBS session (e.g., an F1-U interface tunnel context) be resumed. For example, the first network node 110-1 (e.g., CU-CP) may transmit the MRB tunnel context resumption request via an MRB context modification request message (sometimes referred to herein as an MC bearer context modification request message). Moreover, as indicated by reference number 530, based at least in part on receiving the MRB tunnel context resumption request, the second network node 110-2 (e.g., CU-UP) may transmit, and the first network node 110-1 (e.g., CU-CP) may receive, an MRB tunnel context resumption response, which may indicate a resumption status of the MRB tunnel context (e.g., the F1-U tunnel context).

As indicated by reference number 532, the first network node 110-1 (e.g., CU-CP) and/or the CU 401 may transmit, and the third network node 110-3 (e.g., DU) may receive, an MRB tunnel resumption response indicating that the tunnel is to be resumed. For example, the first network node 110-1 (e.g., CU-CP) and/or the CU 401 may transmit the MRB tunnel resumption response via an IE (e.g., the MRB F1-U tunnel resume IE) included as part of an MBS distribution setup complete message (e.g., the MBS distribution setup complete message described above in connection with reference number 424). In some other aspects, the first network node 110-1 (e.g., CU-CP) and/or the CU 401 may transmit the MRB tunnel resumption response via an MBS distribution modification complete message (e.g., the MBS distribution modification complete message described above in connection with reference number 516). Accordingly, based at least in part on receiving the indication that the F1-U tunnel has been resumed, as indicated by reference number 534, the first network node 110-1 (e.g., CU-CP), the CU 401, and/or the third network node 110-3 (e.g., DU) may trigger RAN paging, may trigger the UE 120 to transition from an RRC inactive state (e.g., RRC_inactive) to an RRC connected state (e.g., RRC_connected) to receive an MBS media flow, and/or may provide the UE 120 with an MRB configuration in order to receive the MBS media flow.

Accordingly, by using the signaling described above in connection with reference numbers 501-516, the various network entities (e.g., the first network node 110-1 (e.g., CU-CP), the second network node 110-2 (e.g., CU-UP), the third network node 110-3 (e.g., DU), and/or the CU 401) may quickly resume an MRB associated with an active MBS session and/or resume an F1-U tunnel associated with an active MBS session without requiring the extensive signaling overhead and resource consumption associated with setup of an MRB and/or F1-U tunnel.

As indicated above, FIG. 5A-5B are provided as an example. Other examples may differ from what is described with respect to FIG. 5A-5B.

FIG. 6 is a diagram illustrating an example process 600 performed, for example, at a first network node or an apparatus of a first network node, in accordance with the present disclosure. Example process 600 is an example where the apparatus or the first network node (e.g., first network node 110-1 and/or CU 401) performs operations associated with suspension and resumption of an MBS.

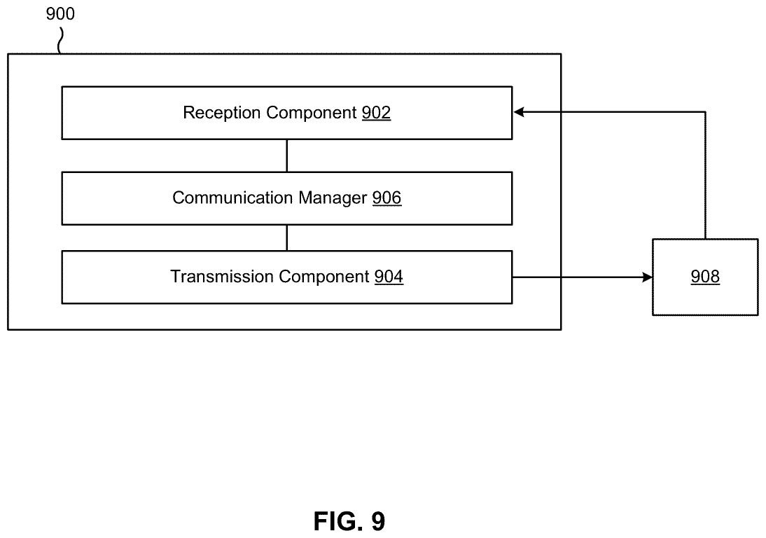

As shown in FIG. 6, in some aspects, process 600 may include receiving, from a second network node, a first MBS data activity message that indicates that no downlink data is available for transmission in an active MBS session (block 610). For example, the first network node (e.g., using reception component 902 and/or communication manager 906, depicted in FIG. 9) may receive, from a second network node, a first MBS data activity message (e.g., a first MC bearer notification message) that indicates that no downlink data is available for transmission in an active MBS session, as described above.

As further shown in FIG. 6, in some aspects, process 600 may include transmitting, to a third network node and based at least in part on receiving the first MBS data activity message, an MRB context suspension indication that indicates that an MRB context associated with the active MBS session is to be suspended (block 620). For example, the first network node (e.g., using transmission component 904 and/or communication manager 906, depicted in FIG. 9) may transmit, to a third network node and based at least in part on receiving the first MBS data activity message, an MRB context suspension indication that indicates that an MRB context associated with the active MBS session is to be suspended, as described above.

Process 600 may include additional aspects, such as any single aspect or any combination of aspects described below and/or in connection with one or more other processes described elsewhere herein.

In a first aspect, the first network node is a central unit-control plane network node, the second network node is a central unit-user plane network node, and the third network node is a distributed unit network node.

In a second aspect, alone or in combination with the first aspect, process 600 includes receiving, from the third network node and based at least in part on transmitting the MRB context suspension indication, an MRB context suspension response that indicates a suspension status of the MRB context.

In a third aspect, alone or in combination with one or more of the first and second aspects, process 600 includes receiving, from the third network node and based at least in part on transmitting the MRB context suspension indication, an MRB tunnel suspension request that requests that a tunnel associated with the active MBS session be suspended.

In a fourth aspect, alone or in combination with one or more of the first through third aspects, the tunnel is an F1-U interface tunnel.

In a fifth aspect, alone or in combination with one or more of the first through fourth aspects, the MRB tunnel suspension request is received via one of an information element included as part of an MBS distribution setup request, or an MBS distribution modification request.

In a sixth aspect, alone or in combination with one or more of the first through fifth aspects, process 600 includes transmitting, to the second network node and based at least in part on receiving the MRB tunnel suspension request, an MRB tunnel context suspension request that requests that a tunnel context associated with the active MBS session be suspended.

In a seventh aspect, alone or in combination with one or more of the first through sixth aspects, the tunnel context is an F1-U interface tunnel context.

In an eighth aspect, alone or in combination with one or more of the first through seventh aspects, the MRB tunnel context suspension request is transmitted via an MRB context modification request message.

In a ninth aspect, alone or in combination with one or more of the first through eighth aspects, process 600 includes transmitting, to the third network node and based at least in part on receiving the MRB tunnel suspension request, an MRB tunnel suspension response indicating that the tunnel is to be suspended.

In a tenth aspect, alone or in combination with one or more of the first through ninth aspects, the MRB tunnel suspension response is transmitted via one of an information element included as part of an MBS distribution release complete message, or an MBS distribution modification complete message.

In an eleventh aspect, alone or in combination with one or more of the first through tenth aspects, process 600 includes receiving, from the second network node, a second MBS data activity message (e.g., a second MC bearer notification message) that indicates that downlink data is available for transmission in the active MBS session, and transmitting, to the third network node and based at least in part on receiving the second MBS data activity message, an MRB context resumption indication that indicates that the MRB context associated with the active MBS session is to be resumed.

In a twelfth aspect, alone or in combination with one or more of the first through eleventh aspects, process 600 includes receiving, from the third network node and based at least in part on transmitting the MRB context resumption indication, an MRB context resumption response that indicates a resumption status of the MRB context.

In a thirteenth aspect, alone or in combination with one or more of the first through twelfth aspects, process 600 includes receiving, from the third network node and based at least in part on transmitting the MRB context resumption indication, an MRB tunnel resumption request that requests that a tunnel associated with the active MBS session be resumed.

In a fourteenth aspect, alone or in combination with one or more of the first through thirteenth aspects, the tunnel is an F1-U interface tunnel.

In a fifteenth aspect, alone or in combination with one or more of the first through fourteenth aspects, the MRB tunnel resumption request is received via one of an information element included as part of an MBS distribution setup request, or an MBS distribution modification request.

In a sixteenth aspect, alone or in combination with one or more of the first through fifteenth aspects, process 600 includes transmitting, to the second network node and based at least in part on receiving the MRB tunnel resumption request, an MRB tunnel context resumption request that requests that a tunnel context associated with the active MBS session be resumed.

In a seventeenth aspect, alone or in combination with one or more of the first through sixteenth aspects, the tunnel context is an F1-U interface tunnel context.

In an eighteenth aspect, alone or in combination with one or more of the first through seventeenth aspects, the MRB tunnel context resumption request is transmitted via an MRB context modification request message.

In a nineteenth aspect, alone or in combination with one or more of the first through eighteenth aspects, process 600 includes transmitting, to the third network node and based at least in part on receiving the MRB tunnel resumption request, an MRB tunnel resumption response indicating that the tunnel is to be resumed.

In a twentieth aspect, alone or in combination with one or more of the first through nineteenth aspects, the MRB tunnel resumption response is transmitted via one of an information element included as part of an MBS distribution setup complete message, or an MBS distribution modification complete message.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a first network node or an apparatus of a first network node, in accordance with the present disclosure. Example process 700 is an example where the apparatus or the first network node (e.g., third network node 110-3) performs operations associated with suspension and resumption of an MBS.

As shown in FIG. 7, in some aspects, process 700 may include receiving, from a second network node, an MRB context suspension indication that indicates that an MRB context associated with an active MBS session is to be suspended (block 710). For example, the first network node (e.g., using reception component 902 and/or communication manager 906, depicted in FIG. 9) may receive, from a second network node, an MRB context suspension indication that indicates that an MRB context associated with an active MBS session is to be suspended, as described above.

As further shown in FIG. 7, in some aspects, process 700 may include transmitting, to the second network node and based at least in part on receiving the MRB context suspension indication, an MRB context suspension response that indicates a suspension status of the MRB context (block 720). For example, the first network node (e.g., using transmission component 904 and/or communication manager 906, depicted in FIG. 9) may transmit, to the second network node and based at least in part on receiving the MRB context suspension indication, an MRB context suspension response that indicates a suspension status of the MRB context, as described above.

Process 700 may include additional aspects, such as any single aspect or any combination of aspects described below and/or in connection with one or more other processes described elsewhere herein.

In a first aspect, the first network node is a distributed unit network node, and the second network node is a central unit network node.

In a second aspect, alone or in combination with the first aspect, process 700 includes transmitting, to the second network node and based at least in part on receiving the MRB context suspension indication, an MRB tunnel suspension request that requests that a tunnel associated with the active MBS session be suspended.

In a third aspect, alone or in combination with one or more of the first and second aspects, the tunnel is an F1-U interface tunnel.

In a fourth aspect, alone or in combination with one or more of the first through third aspects, the MRB tunnel suspension request is transmitted via one of an information element included as part of an MBS distribution setup request, or an MBS distribution modification request.

In a fifth aspect, alone or in combination with one or more of the first through fourth aspects, process 700 includes receiving, from the second network node and based at least in part on transmitting the MRB tunnel suspension request, an MRB tunnel suspension response indicating that the tunnel is to be suspended.

In a sixth aspect, alone or in combination with one or more of the first through fifth aspects, the MRB tunnel suspension response is received via one of an information element included as part of an MBS distribution release complete message, or an MBS distribution modification complete message.

In a seventh aspect, alone or in combination with one or more of the first through sixth aspects, process 700 includes receiving, from the second network node, an MRB context resumption indication that indicates that the MRB context associated with the active MBS session is to be resumed.

In an eighth aspect, alone or in combination with one or more of the first through seventh aspects, process 700 includes transmitting, to the second network node and based at least in part on receiving the MRB context resumption indication, an MRB context resumption response that indicates a resumption status of the MRB context.

In a ninth aspect, alone or in combination with one or more of the first through eighth aspects, process 700 includes transmitting, to the second network node and based at least in part on receiving the MRB context resumption indication, an MRB tunnel resumption request that requests that a tunnel associated with the active MBS session be resumed.

In a tenth aspect, alone or in combination with one or more of the first through ninth aspects, the tunnel is an F1-U interface tunnel.

In an eleventh aspect, alone or in combination with one or more of the first through tenth aspects, the MRB tunnel resumption request is transmitted via one of an information element included as part of an MBS distribution setup request, or an MBS distribution modification request.

In a twelfth aspect, alone or in combination with one or more of the first through eleventh aspects, process 700 includes receiving, from the second network node and based at least in part on transmitting the MRB tunnel resumption request, an MRB tunnel resumption response indicating that the tunnel is to be resumed.

In a thirteenth aspect, alone or in combination with one or more of the first through twelfth aspects, the MRB tunnel resumption response is received via one of an information element included as part of an MBS distribution setup complete message, or an MBS distribution modification complete message.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a first network node or an apparatus of a first network node, in accordance with the present disclosure. Example process 800 is an example where the apparatus or the first network node (e.g., second network node 110-2 and/or CU 401) performs operations associated with suspension and resumption of an MBS.

As shown in FIG. 8, in some aspects, process 800 may include transmitting, to a second network node, a first MBS data activity message that indicates that no downlink data is available for transmission in an active MBS session (block 810). For example, the first network node (e.g., using transmission component 904 and/or communication manager 906, depicted in FIG. 9) may transmit, to a second network node, a first MBS data activity message (e.g., a first MC bearer notification message) that indicates that no downlink data is available for transmission in an active MBS session, as described above.

As further shown in FIG. 8, in some aspects, process 800 may include receiving, from the second network node and based at least in part on transmitting the first MBS data activity message, an MRB tunnel context suspension request that requests that a tunnel context associated with the active MBS session be suspended (block 820). For example, the first network node (e.g., using reception component 902 and/or communication manager 906, depicted in FIG. 9) may receive, from the second network node and based at least in part on transmitting the first MBS data activity message, an MRB tunnel context suspension request that requests that a tunnel context associated with the active MBS session be suspended, as described above.

Process 800 may include additional aspects, such as any single aspect or any combination of aspects described below and/or in connection with one or more other processes described elsewhere herein.

In a first aspect, the first network node is a central unit-user plane network node, and the second network node is a central unit-control plane network node.

In a second aspect, alone or in combination with the first aspect, the tunnel context is an F1-U interface tunnel context.

In a third aspect, alone or in combination with one or more of the first and second aspects, the MRB tunnel context suspension request is transmitted via an MRB context modification request message.

In a fourth aspect, alone or in combination with one or more of the first through third aspects, process 800 includes transmitting, to the second network node, a second MBS data activity message (e.g., a second MC bearer notification message) that indicates that downlink data is available for transmission in the active MBS session.

In a fifth aspect, alone or in combination with one or more of the first through fourth aspects, process 800 includes receiving, from the second network node and based at least in part on transmitting the second MBS data activity message, an MRB tunnel context resumption request that requests that the tunnel context associated with the active MBS session be resumed.

In a sixth aspect, alone or in combination with one or more of the first through fifth aspects, the MRB tunnel context resumption request is received via an MRB context modification request message.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 5A-5B. Additionally, or alternatively, the apparatus 900 may be configured to perform one or more processes described herein, such as process 600 of FIG. 6, process 700 of FIG. 7, process 800 of FIG. 8, or a combination thereof. In some aspects, the apparatus 900 and/or one or more components shown in FIG. 9 may include one or more components of the network node 110 described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the network node 110 described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the network node 110 described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a second network node, a first MBS data activity message that indicates that no downlink data is available for transmission in an active MBS session. The transmission component 904 may transmit, to a third network node and based at least in part on receiving the first MBS data activity message, an MRB context suspension indication that indicates that an MRB context associated with the active MBS session is to be suspended.

The reception component 902 may receive, from the third network node and based at least in part on transmitting the MRB context suspension indication, an MRB context suspension response that indicates a suspension status of the MRB context.

The reception component 902 may receive, from the third network node and based at least in part on transmitting the MRB context suspension indication, an MRB tunnel suspension request that requests that a tunnel associated with the active MBS session be suspended.

The transmission component 904 may transmit, to the second network node and based at least in part on receiving the MRB tunnel suspension request, an MRB tunnel context suspension request that requests that a tunnel context associated with the active MBS session be suspended.

The transmission component 904 may transmit, to the third network node and based at least in part on receiving the MRB tunnel suspension request, an MRB tunnel suspension response indicating that the tunnel is to be suspended.

The reception component 902 may receive, from the second network node, a second MBS data activity message that indicates that downlink data is available for transmission in the active MBS session.

The transmission component 904 may transmit, to the third network node and based at least in part on receiving the second MBS data activity message, an MRB context resumption indication that indicates that the MRB context associated with the active MBS session is to be resumed.

The reception component 902 may receive, from the third network node and based at least in part on transmitting the MRB context resumption indication, an MRB context resumption response that indicates a resumption status of the MRB context.

The reception component 902 may receive, from the third network node and based at least in part on transmitting the MRB context resumption indication, an MRB tunnel resumption request that requests that a tunnel associated with the active MBS session be resumed.

The transmission component 904 may transmit, to the second network node and based at least in part on receiving the MRB tunnel resumption request, an MRB tunnel context resumption request that requests that a tunnel context associated with the active MBS session be resumed.

The transmission component 904 may transmit, to the third network node and based at least in part on receiving the MRB tunnel resumption request, an MRB tunnel resumption response indicating that the tunnel is to be resumed.

The reception component 902 may receive, from a second network node, an MRB context suspension indication that indicates that an MRB context associated with an active MBS session is to be suspended. The transmission component 904 may transmit, to the second network node and based at least in part on receiving the MRB context suspension indication, an MRB context suspension response that indicates a suspension status of the MRB context.

The transmission component 904 may transmit, to the second network node and based at least in part on receiving the MRB context suspension indication, an MRB tunnel suspension request that requests that a tunnel associated with the active MBS session be suspended.

The reception component 902 may receive, from the second network node and based at least in part on transmitting the MRB tunnel suspension request, an MRB tunnel suspension response indicating that the tunnel is to be suspended.

The reception component 902 may receive, from the second network node, an MRB context resumption indication that indicates that the MRB context associated with the active MBS session is to be resumed.

The transmission component 904 may transmit, to the second network node and based at least in part on receiving the MRB context resumption indication, an MRB context resumption response that indicates a resumption status of the MRB context.

The transmission component 904 may transmit, to the second network node and based at least in part on receiving the MRB context resumption indication, an MRB tunnel resumption request that requests that a tunnel associated with the active MBS session be resumed.

The reception component 902 may receive, from the second network node and based at least in part on transmitting the MRB tunnel resumption request, an MRB tunnel resumption response indicating that the tunnel is to be resumed.

The transmission component 904 may transmit, to a second network node, a first MBS data activity message that indicates that no downlink data is available for transmission in an active MBS session. The reception component 902 may receive, from the second network node and based at least in part on transmitting the first MBS data activity message, an MRB tunnel context suspension request that requests that a tunnel context associated with the active MBS session be suspended.

The transmission component 904 may transmit, to the second network node, a second MBS data activity message that indicates that downlink data is available for transmission in the active MBS session.

The reception component 902 may receive, from the second network node and based at least in part on transmitting the second MBS data activity message, an MRB tunnel context resumption request that requests that the tunnel context associated with the active MBS session be resumed.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a first network node, comprising: receiving, from a second network node, a first MBS data activity message that indicates that no downlink data is available for transmission in an active MBS session; and transmitting, to a third network node and based at least in part on receiving the first MBS data activity message, an MRB context suspension indication that indicates that an MRB context associated with the active MBS session is to be suspended.

Aspect 2: The method of Aspect 1, wherein the first network node is a central unit-control plane network node, wherein the second network node is a central unit-user plane network node, and wherein the third network node is a distributed unit network node.

Aspect 3: The method of any of Aspects 1-2, further comprising receiving, from the third network node and based at least in part on transmitting the MRB context suspension indication, an MRB context suspension response that indicates a suspension status of the MRB context.

Aspect 4: The method of any of Aspects 1-3, further comprising receiving, from the third network node and based at least in part on transmitting the MRB context suspension indication, an MRB tunnel suspension request that requests that a tunnel associated with the active MBS session be suspended.

Aspect 5: The method of Aspect 4, wherein the tunnel is an F1-U interface tunnel.

Aspect 6: The method of Aspect 4, wherein the MRB tunnel suspension request is received via one of: an information element included as part of an MBS distribution setup request, or an MBS distribution modification request.

Aspect 7: The method of Aspect 4, further comprising transmitting, to the second network node and based at least in part on receiving the MRB tunnel suspension request, an MRB tunnel context suspension request that requests that a tunnel context associated with the active MBS session be suspended.

Aspect 8: The method of Aspect 7, wherein the tunnel context is an F1-U interface tunnel context.

Aspect 9: The method of Aspect 7, wherein the MRB tunnel context suspension request is transmitted via an MRB context modification request message.

Aspect 10: The method of Aspect 4, further comprising transmitting, to the third network node and based at least in part on receiving the MRB tunnel suspension request, an MRB tunnel suspension response indicating that the tunnel is to be suspended.

Aspect 11: The method of Aspect 10, wherein the MRB tunnel suspension response is transmitted via one of: an information element included as part of an MBS distribution release complete message, or an MBS distribution modification complete message.

Aspect 12: The method of any of Aspects 1-11, further comprising: receiving, from the second network node, a second MBS data activity message that indicates that downlink data is available for transmission in the active MBS session; and transmitting, to the third network node and based at least in part on receiving the second MBS data activity message, an MRB context resumption indication that indicates that the MRB context associated with the active MBS session is to be resumed.

Aspect 13: The method of Aspect 12, further comprising receiving, from the third network node and based at least in part on transmitting the MRB context resumption indication, an MRB context resumption response that indicates a resumption status of the MRB context.

Aspect 14: The method of Aspect 12, further comprising receiving, from the third network node and based at least in part on transmitting the MRB context resumption indication, an MRB tunnel resumption request that requests that a tunnel associated with the active MBS session be resumed.

Aspect 15: The method of Aspect 14, wherein the tunnel is an F1-U interface tunnel.

Aspect 16: The method of Aspect 14, wherein the MRB tunnel resumption request is received via one of: an information element included as part of an MBS distribution setup request, or an MBS distribution modification request.

Aspect 17: The method of Aspect 14, further comprising transmitting, to the second network node and based at least in part on receiving the MRB tunnel resumption request, an MRB tunnel context resumption request that requests that a tunnel context associated with the active MBS session be resumed.

Aspect 18: The method of Aspect 17, wherein the tunnel context is an F1-U interface tunnel context.

Aspect 19: The method of Aspect 17, wherein the MRB tunnel context resumption request is transmitted via an MRB context modification request message.

Aspect 20: The method of Aspect 14, further comprising transmitting, to the third network node and based at least in part on receiving the MRB tunnel resumption request, an MRB tunnel resumption response indicating that the tunnel is to be resumed.

Aspect 21: The method of Aspect 20, wherein the MRB tunnel resumption response is transmitted via one of: an information element included as part of an MBS distribution setup complete message, or an MBS distribution modification complete message.

Aspect 22: A method of wireless communication performed by a first network node, comprising: receiving, from a second network node, an MRB context suspension indication that indicates that an MRB context associated with an active MBS session is to be suspended; and transmitting, to the second network node and based at least in part on receiving the MRB context suspension indication, an MRB context suspension response that indicates a suspension status of the MRB context.

Aspect 23: The method of Aspect 22, wherein the first network node is a distributed unit network node, and wherein the second network node is a central unit network node.

Aspect 24: The method of any of Aspects 22-23, further comprising transmitting, to the second network node and based at least in part on receiving the MRB context suspension indication, an MRB tunnel suspension request that requests that a tunnel associated with the active MBS session be suspended.

Aspect 25: The method of Aspect 24, wherein the tunnel is an F1-U interface tunnel.

Aspect 26: The method of Aspect 24, wherein the MRB tunnel suspension request is transmitted via one of: an information element included as part of an MBS distribution setup request, or an MBS distribution modification request.

Aspect 27: The method of Aspect 24, further comprising receiving, from the second network node and based at least in part on transmitting the MRB tunnel suspension request, an MRB tunnel suspension response indicating that the tunnel is to be suspended.

Aspect 28: The method of Aspect 27, wherein the MRB tunnel suspension response is received via one of: an information element included as part of an MBS distribution release complete message, or an MBS distribution modification complete message.

Aspect 29: The method of any of Aspects 22-28, further comprising: receiving, from the second network node, an MRB context resumption indication that indicates that the MRB context associated with the active MBS session is to be resumed.

Aspect 30: The method of Aspect 29, further comprising transmitting, to the second network node and based at least in part on receiving the MRB context resumption indication, an MRB context resumption response that indicates a resumption status of the MRB context.

Aspect 31: The method of Aspect 29, further comprising transmitting, to the second network node and based at least in part on receiving the MRB context resumption indication, an MRB tunnel resumption request that requests that a tunnel associated with the active MBS session be resumed.

Aspect 32: The method of Aspect 31, wherein the tunnel is an F1-U interface tunnel.

Aspect 33: The method of Aspect 31, wherein the MRB tunnel resumption request is transmitted via one of: an information element included as part of an MBS distribution setup request, or an MBS distribution modification request.

Aspect 34: The method of Aspect 31, further comprising receiving, from the second network node and based at least in part on transmitting the MRB tunnel resumption request, an MRB tunnel resumption response indicating that the tunnel is to be resumed.

Aspect 35: The method of Aspect 34, wherein the MRB tunnel resumption response is received via one of: an information element included as part of an MBS distribution setup complete message, or an MBS distribution modification complete message.

Aspect 36: A method of wireless communication performed by a first network node, comprising: transmitting, to a second network node, a first MBS data activity message that indicates that no downlink data is available for transmission in an active MBS session; and receiving, from the second network node and based at least in part on transmitting the first MBS data activity message, an MRB tunnel context suspension request that requests that a tunnel context associated with the active MBS session be suspended.

Aspect 37: The method of Aspect 36, wherein the first network node is a central unit-user plane network node, and wherein the second network node is a central unit-control plane network node.

Aspect 38: The method of any of Aspects 36-37, wherein the tunnel context is an F1-U interface tunnel context.

Aspect 39: The method of any of Aspects 36-38, wherein the MRB tunnel context suspension request is transmitted via an MRB context modification request message.

Aspect 40: The method of any of Aspects 36-39, further comprising: transmitting, to the second network node, a second MBS data activity message that indicates that downlink data is available for transmission in the active MBS session.

Aspect 41: The method of Aspect 40, further comprising receiving, from the second network node and based at least in part on transmitting the second MBS data activity message, an MRB tunnel context resumption request that requests that the tunnel context associated with the active MBS session be resumed.

Aspect 42: The method of Aspect 41, wherein the MRB tunnel context resumption request is received via an MRB context modification request message.

Aspect 43: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-42.

Aspect 44: An apparatus for wireless communication at a device, the apparatus comprising one or more memories and one or more processors coupled to the one or more memories, the one or more processors individually or collectively configured to cause the device to perform the method of one or more of Aspects 1-42.

Aspect 45: An apparatus for wireless communication, the apparatus comprising at least one means for performing the method of one or more of Aspects 1-42.

Aspect 46: A non-transitory computer-readable medium storing code for wireless communication, the code comprising instructions executable by one or more processors to perform the method of one or more of Aspects 1-42.

Aspect 47: A non-transitory computer-readable medium storing a set of instructions for wireless communication, the set of instructions comprising one or more instructions that, when executed by one or more processors of a device, cause the device to perform the method of one or more of Aspects 1-42.

Aspect 48: A device for wireless communication, the device comprising a processing system that includes one or more processors and one or more memories coupled with the one or more processors, the processing system configured to cause the device to perform the method of one or more of Aspects 1-42.

Aspect 49: An apparatus for wireless communication at a device, the apparatus comprising one or more memories and one or more processors coupled to the one or more memories, the one or more processors individually or collectively configured to cause the device to perform the method of one or more of Aspects 1-42.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of”' a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first network node for wireless communication, comprising:
one or more memories; and
one or more processors, coupled to the one or more memories, the one or more processors individually or collectively configured to cause the first network node to:
receive, from a second network node, a first multicast/broadcast service (MBS) data activity message that indicates that no downlink data is available for transmission in an active MBS session; and
transmit, to a third network node and based at least in part on receiving the first MBS data activity message, a multicast/broadcast radio bearer (MRB) context suspension indication that indicates that an MRB context associated with the active MBS session is to be suspended.

2. The first network node of claim 1, wherein the first network node is a central unit-control plane network node,
wherein the second network node is a central unit-user plane network node, and
wherein the third network node is a distributed unit network node.

3. The first network node of claim 1, wherein the one or more processors are further individually or collectively configured to cause the first network node to transmit, to the second network node, an MRB tunnel context suspension request that requests that a tunnel context associated with the active MBS session be suspended.

4. The first network node of claim 3, wherein the tunnel context is an F1-U interface tunnel context.

5. The first network node of claim 3, wherein, to cause the first network node to transmit the MRB tunnel context suspension request, the one or more processors are further individually or collectively configured to cause the first network node to transmit the MRB tunnel context suspension request via an MRB context modification request message.

6. The first network node of claim 1, wherein the one or more processors are further individually or collectively configured to cause the first network node to:
receive, from the second network node, a second MBS data activity message that indicates that downlink data is available for transmission in the active MBS session; and
transmit, to the third network node and based at least in part on receiving the second MBS data activity message, an MRB context resumption indication that indicates that the MRB context associated with the active MBS session is to be resumed.

7. The first network node of claim 6, wherein the one or more processors are further individually or collectively configured to cause the first network node to transmit, to the second network node, an MRB tunnel context resumption request that requests that a tunnel context associated with the active MBS session be resumed.

8. The first network node of claim 7, wherein the tunnel context is an F1-U interface tunnel context.

9. The first network node of claim 7, wherein, to cause the first network node to transmit the MRB tunnel context resumption request, the one or more processors are individually or collectively configured to cause the first network node to transmit the MRB tunnel context resumption request via an MRB context modification request message.

10. A first network node for wireless communication, comprising:
one or more memories; and
one or more processors, coupled to the one or more memories, the one or more processors individually or collectively configured to cause the first network node to:
transmit, to a second network node, a first multicast/broadcast service (MBS) data activity message that indicates that no downlink data is available for transmission in an active MBS session; and
receive, from the second network node and based at least in part on transmitting the first MBS data activity message, a multicast/broadcast radio bearer (MRB) tunnel context suspension request that requests that a tunnel context associated with the active MBS session be suspended.

11. The first network node of claim 10, wherein the first network node is a central unit-user plane network node, and
wherein the second network node is a central unit-control plane network node.

12. The first network node of claim 10, wherein the tunnel context is an F1-U interface tunnel context.

13. The first network node of claim 10, wherein, to cause the first network node to transmit the MRB tunnel context suspension request, the one or more processors are individually or collectively configured to cause the first network node to transmit the MRB tunnel context suspension request via an MRB context modification request message.

14. The first network node of claim 10, wherein the one or more processors are further individually or collectively configured to cause the first network node to:
transmit, to the second network node, a second MBS data activity message that indicates that downlink data is available for transmission in the active MBS session.

15. The first network node of claim 14, wherein the one or more processors are further individually or collectively configured to cause the first network node to receive, from the second network node and based at least in part on transmitting the second MBS data activity message, an MRB tunnel context resumption request that requests that the tunnel context associated with the active MBS session be resumed.

16. The first network node of claim 15, wherein, to cause the first network node to receive the MRB tunnel context resumption request, the one or more processors are individually or collectively configured to cause the first network node to receive the MRB tunnel context resumption request via an MRB context modification request message.

17. A method of wireless communication performed by a first network node, comprising:
receiving, from a second network node, a first multicast/broadcast service (MBS) data activity message that indicates that no downlink data is available for transmission in an active MBS session; and
transmitting, to a third network node and based at least in part on receiving the first MBS data activity message, a multicast/broadcast radio bearer (MRB) context suspension indication that indicates that an MRB context associated with the active MBS session is to be suspended.

18. The method of claim 17, wherein the first network node is a central unit-control plane network node,
wherein the second network node is a central unit-user plane network node, and
wherein the third network node is a distributed unit network node.

19. The method of claim 17, further comprising transmitting, to the second network node, an MRB tunnel context suspension request that requests that a tunnel context associated with the active MBS session be suspended.

20. The method of claim 19, wherein the tunnel context is an F1-U interface tunnel context.

21. The method of claim 19, wherein the MRB tunnel context suspension request is transmitted via an MRB context modification request message.

22. The method of claim 17, further comprising:
receiving, from the second network node, a second MBS data activity message that indicates that downlink data is available for transmission in the active MBS session; and
transmitting, to the third network node and based at least in part on receiving the second MBS data activity message, an MRB context resumption indication that indicates that the MRB context associated with the active MBS session is to be resumed.

23. The method of claim 22, further comprising transmitting, to the second network node, an MRB tunnel context resumption request that requests that a tunnel context associated with the active MBS session be resumed.

24. The method of claim 23, wherein the MRB tunnel context resumption request is transmitted via an MRB context modification request message.

25. A method of wireless communication performed by a first network node, comprising:
transmitting, to a second network node, a first multicast/broadcast service (MBS) data activity message that indicates that no downlink data is available for transmission in an active MBS session; and
receiving, from the second network node and based at least in part on transmitting the first MBS data activity message, a multicast/broadcast radio bearer (MRB) tunnel context suspension request that requests that a tunnel context associated with the active MBS session be suspended.

26. The method of claim 25, wherein the first network node is a central unit-user plane network node, and
wherein the second network node is a central unit-control plane network node.

27. The method of claim 25, wherein the MRB tunnel context suspension request is transmitted via an MRB context modification request message.

28. The method of claim 25, further comprising:
transmitting, to the second network node, a second MBS data activity message that indicates that downlink data is available for transmission in the active MBS session.

29. The method of claim 28, further comprising receiving, from the second network node and based at least in part on transmitting the second MBS data activity message, an MRB tunnel context resumption request that requests that the tunnel context associated with the active MBS session be resumed.

30. The method of claim 29, wherein the MRB tunnel context resumption request is received via an MRB context modification request message.
